(19) United States
(12) Patent Application Publication
(10) Pub. No.: US 2010/0167130 A1
(43) Pub. Date: Jul. 1, 2010

(54) ELECTROCHEMICAL ENERGY SOURCE AND ELECTRONIC DEVICE PROVIDED WITH SUCH AN ELECTROCHEMICAL ENERGY SOURCE

(75) Inventors: Remco Henricus Wilhelmus Pijnenburg, Eindhoven (NL); Petrus Henricus Laurentius Notten, Eindhoven (NL); Youri Victorovitch Ponomarev, Leuven (BE); Rogier Adrianus Henrica Niessen, Eindhoven (NL); Johannes Hubertus Gerardus Op Het Veld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,041

(22) PCT Filed: Sep. 10, 2007
(86) PCT No.: PCT/IB2007/053628

§ 371 Date: Feb. 19, 2009

(30) Foreign Application Priority Data
Sep. 14, 2006 (EP) 06120652.0

(51) Int. Cl. H01M 6/18

(52) U.S. Cl. 429/304

(57) ABSTRACT

The invention relates to an improved electrochemical energy source, comprising: a substrate, and at least one stack deposited onto said substrate, the stack comprising: an first electrode, a second electrode, and an intermediate solid-state electrolyte separating the first electrode and the second electrode. The invention also relates to an electronic device provided with such an electrochemical energy source.

### FIELD OF THE INVENTION

The invention relates to an improved electrochemical energy source. The invention also relates to an electronic device provided with such an electrochemical energy source.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO 00/25378, where a solid-state thin-film micro battery is fabricated directly onto a specific substrate. During this fabrication process the first electrode, the intermediate solid-state electrolyte, and the second electrode are subsequently deposited as a stack onto the substrate. Although the known micro battery exhibits commonly superior performance as compared to other solid-state batteries, the known micro battery has several drawbacks. A major drawback of the known micro battery of WO 00/25378 is that applying a shielding packaging to the stack surrounding the stack at least partially, this packaging will commonly easily crack due to a significant expansion and contraction of both electrodes during operation.

It is an object of the invention to provide an improved electrochemical energy source without suffering from at least one of the drawback mentioned above.

### SUMMARY OF THE INVENTION

This object can be achieved by providing an electrochemical energy source according to the preamble, comprising: a substrate, and at least one stack deposited onto said substrate, the stack comprising: an first electrode, a second electrode, and an intermediate solid-state electrolyte separating the first electrode and the second electrode; and at least one electron-conductive barrier layer being deposited between the substrate and the stack, which barrier layer is adapted to at least substantially preclude diffusion of active species of the stack into said substrate, wherein the energy source further comprises at least one material layer surrounding the stack at least partially, and a stress reducing means positioned between the stack and the surrounding material layer for reducing stress in the surrounding material layer during expansion and contraction of the stack. By applying the material stress reducing means between the surrounding material layer and the stack, a built-up of material stress at the interface of the surrounding material layer and the stack, due to expansion and contraction of the electrode(s) during operation of the electrochemical energy source, can be compensated. Deteroriation, and in particular cracking or breaking, of the surrounding layer and/or the stack can be counteracted in this manner. Due to the application of the material stress reducing means in the electrochemical energy source according to the invention the freedom of design of the electrochemical source can be increased significantly. In particular the freedom of choice of applicable surrounding layers is increased due to the application of the material stress reducing means. In the electrochemical energy source according to the invention it is therefore conceivable to apply a substantially rigid surrounding layer to cover the stack at least partially. The material layer surrounding the stack at least partially can be of various nature. The surrounding material layer may act as a packaging being adapted to preserve active species within the stack and/or may be adapted to prevent atmospheric compounds, such as oxygen en nitrogen, surrounding the packaging to enter the stack, in order to protect the stack to secure a long-term performance of the electrochemical energy source according to the invention.

However, it is also conceivable that the surrounding material layer serves another purpose, as the surrounding material layer may for example also act as a spacer to separate two different stacks of the electrochemical energy source according to the invention. The first electrode preferably comprises an anode, and the second electrode preferably comprises a cathode. It is common that both an anode and a cathode are deposited during depositing of the stack onto the substrate. Preferably, at least one electrode of the energy source according to the invention is adapted for storage of active species of at least one of following elements: hydrogen (H), lithium (Li), beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of batteries, e.g. Li-ion batteries, NiMH batteries, et cetera. In a preferred embodiment at least one electrode, more preferably the anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the electrode is adapted for intercalation and storing of the abovementioned reactive species. The aforementioned materials are in particularly suitable to be applied in lithium ion batteries. In case a hydrogen based energy source is applied, the anode preferably comprises a hydride forming material, such as AB₅-type materials, in particular LaNi5, and such as magnesium based alloys, in particular MgₓTi₁₋ₓ.

The cathode for a lithium ion based energy source preferably comprises at least one metal-oxide based material, e.g. LiCoO₂, LiNiO₂, LiMnO₂ or a combination of these such as. e.g. Li(NiCoMn)O₂. In case of a hydrogen based energy source, the cathode preferably comprises Ni(OH)₂ and/or NiM(OH)₂, wherein M is formed by one or more elements selected from the group of e.g. Cd, Co, or Bi.

In a preferred embodiment at least one electrode of the first electrode and the second electrode comprises at least one current collector. It is generally known to apply current collectors as electrode terminals. In case e.g. a Li-ion battery with a LiCoO₂ electrode (acting as cathode) is applied, preferably an aluminum current collector is connected to the LiCoO₂ electrode. Alternatively or in addition preferably the at least one current collector is made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied to act as current collector. In case an electron-conductive barrier layer is applied this barrier layer may be used to function as a current collector for the anode. More preferably, at least a part of each current collector is left uncovered by the surrounding material layer in order to enable a facilitated connection of the energy source according to the invention with an electronic module or device. Other parts of the outer surface of the stack (besides a part of the current collectors) are preferably fully covered by the surrounding material layer in a substantially mediumtight manner. In a particular preferred embodiment at least one of the current collectors is formed by a conductive substrate onto which the adjacent electrode is deposited. The integration of the current collector and the first substrate supporting (among others) the energy source commonly leads to a relatively simple construction of the energy source according to the invention. Moreover, the way of manufacturing of the energy source is also simpler, as at least one process step can be eliminated. The relatively simple manufacturing method of the energy system according to the invention may furthermore lead to a significant cost saving. In this context it is mentioned that the first electrode commonly comprises both an anode and a (first) current collector, and that the second electrode commonly comprises both a cathode and a (second) current collector. However, it is also conceivable for a person skilled in the art, that the stack alternatively comprises a first current collector, an electrolyte deposited onto the first current collector, a cathode deposited onto the electrolyte, and a second current collector deposited onto the cathode. Hence, no separate anode layer is deposited during manufacturing of the stack. However, an anode will commonly be formed on the first current collector, or in fact between the first current collector and the electrolyte, during operation of the electrochemical source. For example, during manufacturing of a lithium ion type battery, metallic lithium will be deposited onto a first current collector during operation of the battery, and will subsequently act as an anode material in the battery. In this context, it is noted that both a regular stack (anode directed towards the substrate) and a reverse stack (cathode directed towards the substrate) can be incorporated in the electrochemical energy source according to the invention.

The electrolyte applied in the energy source according to the invention may be based either on ionic conduction mechanisms and non-electronic conduction mechanisms, e.g. ionic conductors for hydrogen (H), lithium (Li), beryllium (Be), magnesium (Mg), aluminium (Al), copper (Cu), silver (Ag), sodium (Na) and potassium (K). A solid-state electrolyte will commonly be used. However, it is also conceivable to apply a liquid-state electrolyte or a mix of a solid-state and liquid-state electrolyte, such as a gel based polymer. Besides, a polymer based electrolyte may also be used. An example of a Li conductor as solid-state electrolyte is Lithium Phosphorus Oxynitride (LiPON). Other known solid-state electrolytes like e.g. Lithium Niobate (LiNbO₃), Lithium Tantalate (LiTaO₃), Lithium orthotungstate (Li₂WO₄), Lithium Germanium Oxynitride (LiGeON), Li₅La₃ Ta₂O₁₂ (Garnet-type class), Li₁₄ZnGe₄O₁₆ (lisicon), Li₃N, beta-aluminas, or Li_{1.3}Ti_{1.7}Al_{0.3}(PO₄)₃ (nasicon-type) may also be used as lithium conducting solid-state electrolyte. A hydrogen conducting electrolyte may for example be formed by CaF₂, TiO(OH), or ZrO₂Hₓ. Detailed information on hydrogen conducting electrolytes is disclosed in the international application WO 02/42831.

The stress reducing means preferably comprises at least one stress reducing cavity formed between the stack and the surrounding material layer. By applying the at least one stress reducing cavity physical contact between (one or multiple critical parts of) the stack and the surrounding material layer can be eliminated, as a consequence of which a built-up of material stress, due to expansion and contraction of the stack during operation, can be prevented or at least counteracted. The at least one cavity can be made by using standard MEMS processes. The at least one stress reducing cavity can be substantially vacuum, or can at least be held in a state of underpressure. However, it is also conceivable that the cavity is filled with a medium, preferably a gas, which medium is more preferably substantially inert with respect to the active species contained by the stack. It is expected that the cavity will also be suitable to act as a barrier to preclude diffusion of active species contained by the stack into the surrounding material layer. To minimize physical contact between the surrounding material layer and the stack, or at least distorting parts of the stack, in particular the anode and the cathode of the stack, preferably multiple stress reducing cavities are applied.

In an alternative preferred embodiment the stress reducing means comprises at least one flexible element to reduce a built-up of material stress within the surrounding material layer. In fact, during expansion and contraction of the stack, and in particular the electrode(s), the energy transferred to the at least one flexible element will substantially be absorbed by said at least one flexible element, as a result of which no (considerable) material stress will be present within the surrounding material layer. It is expected that the minimum thickness of the at least one flexible element, required to reduce a built-up of material stress within the surrounding material layer in a satisfying manner, is larger than such a minimum thickness in case a stress reducing cavity (instead of a flexible element) would be applied. In a preferred embodiment multiple flexible elements are applied to enable a satisfying covering (critical part(s) of) the stack. In a particular preferred embodiment, the at least one flexible element is made of at least one polymer, more preferably parylene. Polymers, in particular elastomers, in more in particularly parylene are ideally suitable to coat the stack at least partially and substantially uniformly (without voids). Moreover, parylene has a small Young's modulus (˜4 GPa), is a non-brittle material with a large linear-elastic range (yield strain˜3%), which allows large deflection without failure. For a person skilled in the art, it could also be conceivable that the flexible element comprises other materials, and preferably ductile metals, in particular copper, silver, gold, et cetera.

Preferably, the material stress reducing means is adapted for separating different stacks of the energy source according to the invention. In this latter case, the at least one flexible element and/or the at least one material stress reducing cavity will simultaneously cover multiple stacks at least partially. It is preferably that the flexible element, if applied, is also electrically insulating to prevent short-circuiting between different stacks. By applying multiple stacks in a single electrochemical source according to the invention the capacity, and hence the performance of the energy source can be improved significantly.

The surrounding material preferably comprises a packaging covering an outer surface of said stack at least partially to shield, and hence to protect the stack against the atmosphere surrounding the stack. Preferably, the packaging is electrically insulating and substantially impermeable for active species contained by the stack. More preferably, packaging being electrically insulating and substantially impermeable for atmospheric compounds. It has been found that the significant deterioration of performance of the known batteries is substantially caused by penetration of atmospheric compounds, initially surrounding the energy source, into the energy source, as a consequence of which chemical reactions will occur between the penetrated atmospheric compounds on one side and active species, such as ions and particular atoms, contained by the stack on the other side. By applying the surrounding material layer as a protective packaging around the stack of the electrochemical energy source contact between atmospheric compounds and reactive species contained by the stack as well as a consequent a significant reduction of the number of active species present in the stack, can be prevented, or at least be counteracted, as a result of which the performance of the (thin-film) energy source will not be deteriorated significantly.

Preferably, the (commonly initially uncovered) outer surface of the stack is completely or at least substantially covered by the protective packaging to eliminate contact between the atmospheric compounds and the active species contained by the stack. The protective packaging thus acts as a chemical barrier to shield the reactive species and other particles contained by the stack against relatively aggressive atmospheric compounds. The reactive atmospheric compounds are commonly mainly formed by nitrogen (N₂), oxygen (O₂), and water (H₂O) and any derivative (reaction) product thereof. The protective packaging is electrically insulating to prevent short-circuiting of the first electrode and the second electrode. The barrier layer is preferably at least substantially made of at least one of the following compounds: tantalum, tantalum nitride, titanium, and titanium nitride. The material of the barrier layer is however not limited to these compounds. These compounds have as common property a relatively dense structure which is impermeable for the intercalating species, among which lithium (ions).

In a preferred embodiment the substrate(s) is/are made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. A surface of the substrate onto which the stack is deposited may be either substantially flat to obtain a substantially planar stack or may be patterned (by curving the substrate and/or providing the substrate with trenches, holes and/or pillars) to obtain a threedimensional oriented stack. Advantage of the application of a threedimensional oriented stack is the increase of the contact surface per volume between both electrodes and the solid-state electrolyte. Commonly, this increase of the contact surface(s) between the components of the energy source according to the invention leads to an improved rate capability of the energy source, and hence a better battery performance (due to an optimal utilization of the volume of the layers of the energy source). In this way the power density and energy density in the energy source may be maximized and thus optimized. The nature, shape, and dimensioning of the pattern may be arbitrary.

The invention also relates to an electronic device provided with at least one electrochemical energy source according to the invention. An example of such an electric device is a shaver, wherein the electrochemical energy source may function for example as backup (or primary) power source. Other applications which can be enhanced by providing a backup power supply comprising an energy system according to the invention are for example portable RF modules (like e.g. cell phones, radio modules, et cetera), sensors and actuators in (autonomous) micro systems, energy and light management systems, but also digital signal processors and autonomous devices for ambient intelligence. It may be clear this enumeration may certainly not being considered as being limitative. Another example of an electric device wherein an energy source according to the invention may be incorporated (or vice versa) is a so-called ‘system-in-package’ (SiP). In a system-in-package one or multiple electronic components and/or devices, such as integrated circuits (ICs), chips, displays, et cetera, are embeddded at least partially in the substrate, in particularly a monocrystalline silicon conductive substrate, of the electrochemical energy source according to the invention.

### BRIEF DESCRIPTION OF THE DRAWINGS

The invention is illustrated by way of the following non-limitative examples, wherein:

FIG. 1a shows a schematic cross section of a lithium ion battery known from the prior art in a discharged state,

FIG. 1b shows a schematic cross section of the lithium ion battery according to FIG. 1a in a charged state,

FIG. 1c shows a schematic cross section of the lithium ion battery according to FIG. 1a in a discharged state wherein local material stress in the battery is shown,

FIG. 1d shows a schematic cross section of the lithium ion battery according to FIG. 1a in a charged state wherein local material stress in the battery is shown,

FIG. 2a shows a schematic cross section of a lithium ion battery according to the invention in a discharged state,

FIG. 2b shows a schematic cross section of the lithium ion battery according to FIG. 2a in a charged state,

FIG. 3a shows a schematic cross section of another lithium ion battery according to the invention in a discharged state,

FIG. 3b shows a schematic cross section of the lithium ion battery according to FIG. 3a in a charged state, and

FIG. 4 shows a schematic cross section of yet another lithium ion battery according to the invention in a charged state.

### DETAILED DESCRIPTION OF EMBODIMENTS

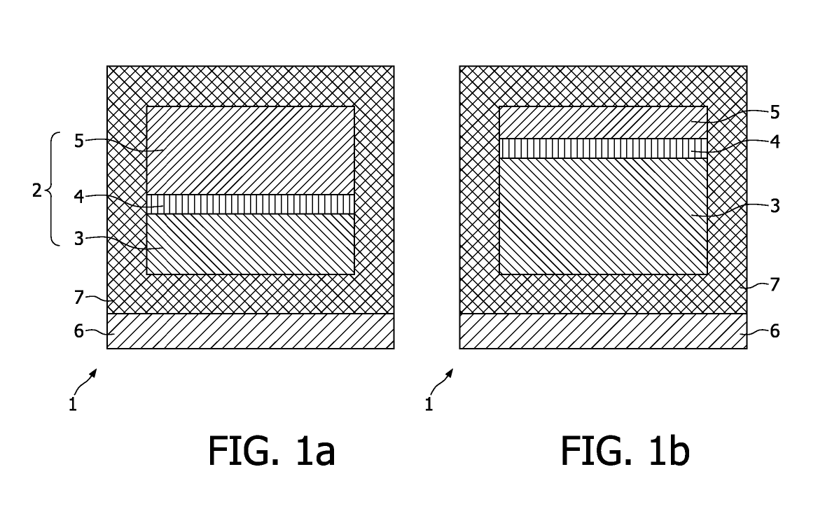

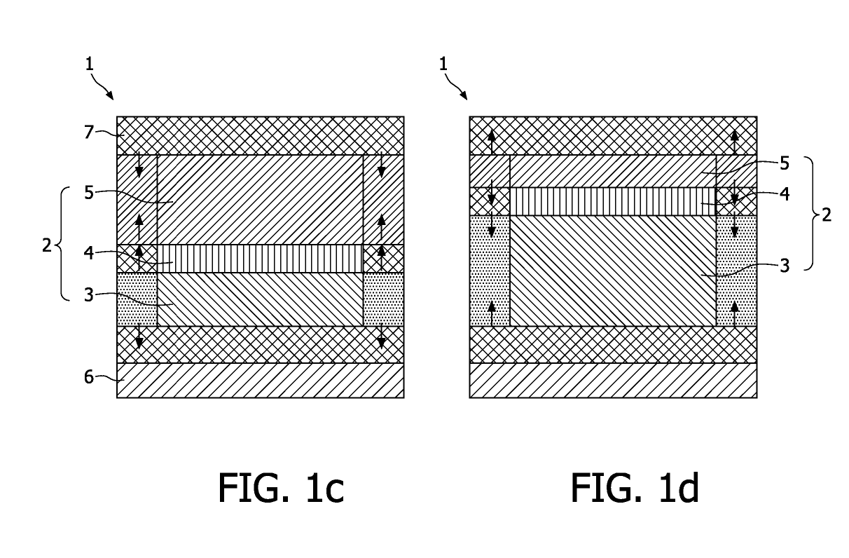

FIG. 1a shows a schematic cross section of a lithium ion battery 1 known from the prior art in a discharged state. The battery 1 comprises a stack 2 of a anode 3 (including a current collector), a solid-state electrolyte 4, and a cathode 5 (including a current collector), which battery stack 2 is deposited onto a silicon substrate 6 in which one or more electronic components (not shown) may be embedded. In the known battery 1 the anode 3 is made of amorphous silicon (a-Si) and the cathode 5 is made of a metal-oxide, such as LiCoO₂, LiMnO₂, LiNiO₂, et cetera. The electrolyte 4 used may be made of LiPON. Between the battery stack 2 and the substrate 6 a lithium barrier layer 7 made of tantalum is deposited onto the substrate 6. In this example, a protective packaging 39 surrounds the stack 2 to be able to conserve all active species within the stack 2. Hence, diffusion of lithium ions (or other active species) initially contained by the stack 2 into the substrate 6 can be counteracted by means of the lithium ion barrier layer 7. The protective packaging 39 is preferably made of at least one insulating material, and may comprise a laminate of alternating layers, each layer of said alternating layers being made of at least one material chosen from the following group of materials: metals, polymers, and siliceous compounds. An example of alternating layers which may be applied in the laminate of the protective packaging 39 is a so-called NONON-layer configuration consisting of silicon nitride (N) and of silica (O) layers deposited on top of each other in an alternating manner. The laminate will commonly further also comprise a metal layer, which is commonly substantially impermeable both for atmospheric compounds and for migrating reactive species contained by the stack 2. Deposition of the individual layers 3, 4, 5, 7 can be achieved, for example, by means of CVD, PVD, or (wet) chemical deposition. In the discharged state of the lithium ion battery 1 as shown the anode 3 is in a contracted state and the cathode 5 is in an expanded state. FIG. 1b shows a schematic cross section of the lithium ion battery according 1 to FIG. 1a in a charged state. In this figure it is clearly shown that the (charged) anode 3 has been expanded, while the cathode 5 has been contracted. As shown in FIGS. 1c and 1d material stress will be built up in the barrier layer 7 during operation of the battery 1, as a result of the barrier layer 7 may break (or crack) in case this material stress becomes too large which will commonly affect a reliable shielding of the stack 2 by means of the barrier layer 7 and will commonly lead to a deterioration of the performance of the battery 1 both in short term and in long term.

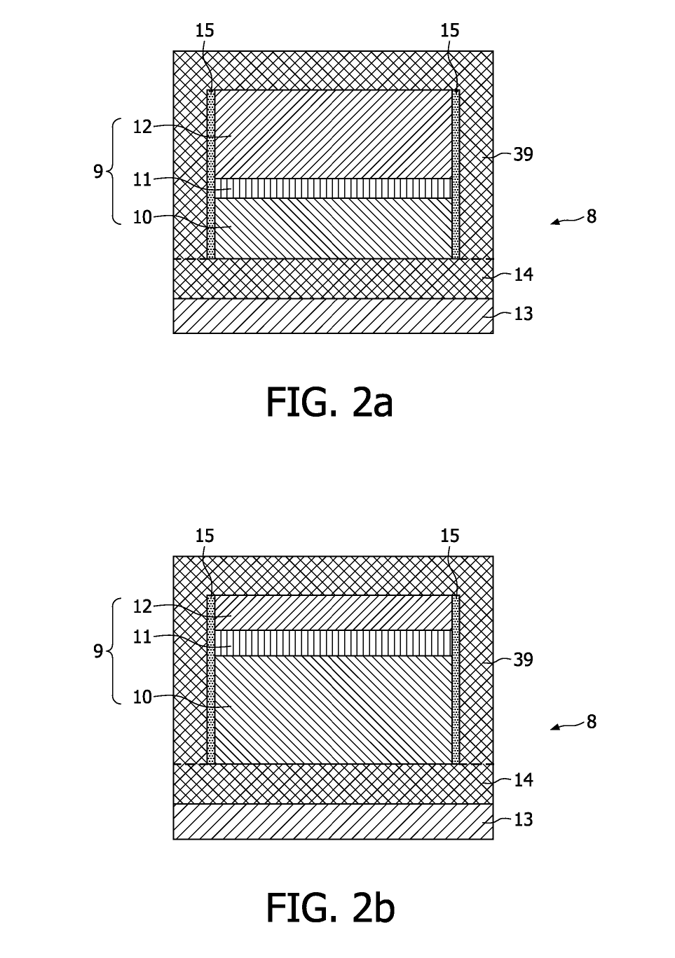

FIGS. 2a and 2b each show a schematic cross section of a lithium ion battery 8 according to the invention in a discharged state and in a charged state respectively. The battery 8 comprises a stack 9 of a anode 10 (including a current collector), a solid-state electrolyte 11, and a cathode 12 (including a current collector), which battery stack 9 is deposited onto a silicon substrate 13 in which one or more electronic components (not shown) may be embedded. In the battery 8 according to the invention the anode 10 is preferably made of amorphous silicon (a-Si) and the cathode 12 is preferably made of a metal-oxide, such as LiCoO₂, LiMnO₂, LiNiO₂, et cetera. In this example, the electrolyte 4 used is made of LiPON. Between the battery stack 9 and the substrate 13 a lithium barrier layer 14 is deposited onto the substrate 13. The barrier layer 14 is preferably made of tantalum, titanium, tantalum nitride, and titanium nitride. In this illustrative example, the barrier layer 14 completely surrounds the stack 9 to be able to conserve all active species within the stack 9. Hence, diffusion of lithium ions (or other active species) initially contained by the stack 9 into the substrate 13 or other media can be counteracted by means of the lithium ion barrier layer 14. Again, deposition of the individual layers 10, 11, 12, 14 can be achieved, for example, by means of CVD, PVD or (wet) chemical deposition. In the battery 8 according to the invention, two material stress reducing cavities 15 are applied between (side walls of) the stack 9 and the barrier layer 14 by means of which the interface between the stack 9 and the barrier layer 14 is selectively interrupted, to prevent a considerably built-up of material stress within the barrier layer 14, and hence breaking of the barrier layer 14, due to expansion and contraction of the anode 10 and the cathode 12 during operation of the battery 8. In this context it is noted that the total volume of the stack as shown in FIGS. 2a and 2b will be substantially constant during battery operation (see FIGS. 2a and 2b) due to an equilibrated choice of anode and cathode materials. In case this total volume would not be substantially constant during battery operation, preferably an additional material stress reducing cavity (not shown) is applied on top of the stack 9. By applying the material stress reducing cavities the expected life span of the barrier layer 14 can commonly be preserved relatively long-lastingly.

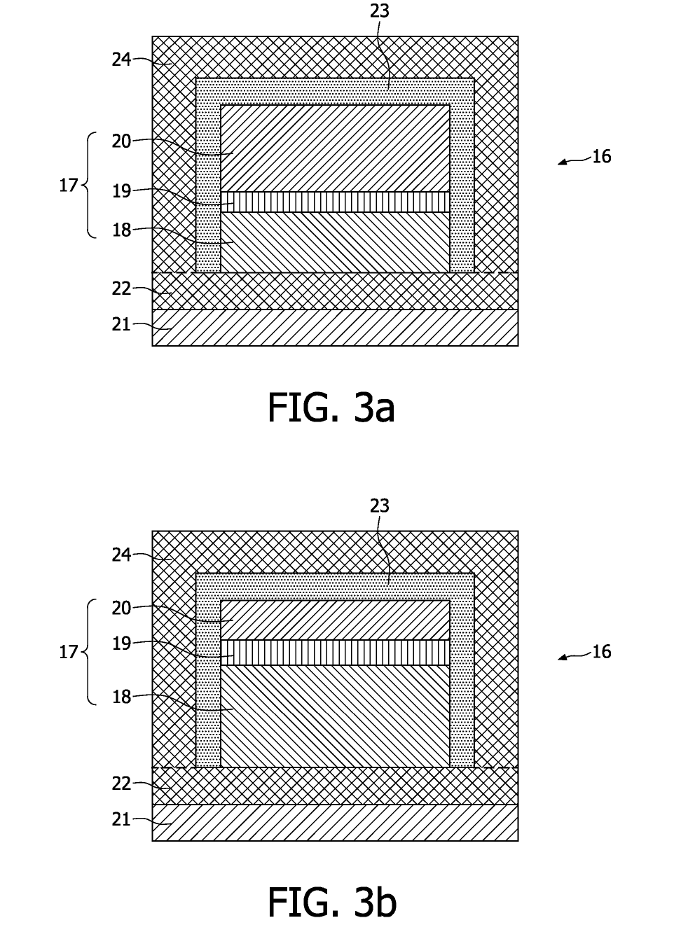

FIGS. 3a and 3b each show a schematic cross section of a lithium ion battery 16 according to the invention in a discharged state and in a charged state respectively. The battery 16 as shown in FIGS. 3a and 3b is constructively more or less similar to the battery 8 as shown in FIGS. 2a and 2b, and comprises a stack 17 of a anode 18 (including a current collector), a solid-state electrolyte 19, and a cathode 20 (including a current collector), which battery stack 17 is deposited onto a silicon substrate 21 in which one or more electronic components (not shown) may be embedded. In the battery 16 according to the invention the anode 18 is preferably made of amorphous silicon (a-Si) and the cathode 20 is preferably made of a metal-oxide, such as LiCoO₂, LiMnO₂, LiNiO₂, et cetera. The electrolyte 4 used in this example is preferably made of LiPON. Between the battery stack 18 and the substrate 21 a lithium barrier layer 22 is deposited onto the substrate 21. The barrier layer 22 is preferably made of tantalum, titanium, tantalum nitride, and titanium nitride. The barrier layer 22 is adapted to preclude diffusion of active species initially contained by the stack 17 into the substrate 21. Both side walls and a top surface is covered by a flexible insulating layer 23 on top of which a shielding barrier layer 24 is deposited. Both barrier layers 22, 24 may form a single integral layer. However, it is also conceivable that both barrier layers 22, 24 are made of different materials. Commonly, the shielding barrier layer 24 will also be adapted to conserve active species within the stack 17. However, it is also imaginable for a person skilled in the art that the shielding barrier layer 24 is adapted to prevent lithium ions contained by the stack 17 to interact with atmospheric compounds surrounding the battery 16. Interaction between the (lithium) active species contained by the stack 17 and atmospheric compounds, in particular molecular oxygen, molecular nitrogen, and water, would namely significantly deteriorate the performance of the battery 1. In this example, the shielding barrier layer 24 acts as a seal, and may be formed by a laminate (not shown) of a silica layer on top of which a tantalum layer is deposited. The conductive tantalum layer acts as a chemical barrier, since this layer is substantially impermeable for both lithium ions and atmospheric compounds. Application of the flexible layer 22, preferably made of parylene, absorbs a substantial part of the deformation energy generated by the stack 17 during battery operation, which is advantageous to prevent a substantial built-up of material stress in the shielding barrier layer 24. In this manner, the intactness of the barrier layer 24, and hence the performance of the battery 16 can be secured in a relatively reliable manner.

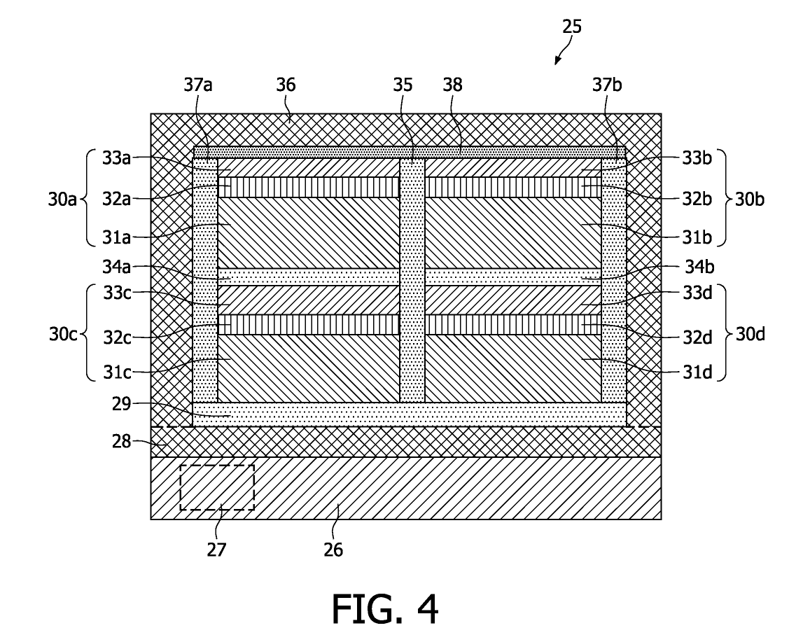

FIG. 4 shows a schematic cross section of yet another lithium ion battery 25 according to the invention in a charged state. The battery 25 comprises a silicon substrate 26 in which one or more electronic components 27, such as IC's, are embedded. On top of the substrate 26 a lower barrier layer 28 and an lower dielectric layer 29 are successively deposited. The lower barrier layer 28 is preferably made of tantalum, titanium, tantalum nitride, or titanium nitride, and the isolating lower dielectric layer 29 is preferably made of an oxide, such as silicon oxide. On top of the lower dielectric layer 29 multiple stacks 30a, 30b, 30c, 30d are deposited, wherein two piles of each two stacks 30a, 30b, 30c, 30d are deposited. Each stack comprises an anode 31a, 31b, 31c, 31d, a current collector (not shown) coupled to the anode 31a, 31b, 31c, 31d, a solid-state electrolyte 32a, 32b, 32c, 32d, a cathode 33a, 33b, 33c, 33d, and a current collector (not shown) coupled to the cathode 33a, 33b, 33c, 33d. The anode 31a, 31b, 31c, 31d of each stack 30a, 30b, 30c, 30d is in the charged (expanded) state in the battery 25 shown in this figure. The stacks 30a, 30b, 30c, 30d of each pile are mutually separated by an intermediate dielectric layer 34a, 34b, while the piles as such are mutually separated by a flexible spacer 35 to be able to counterbalance an expansion and contraction of the anode 31a, 31b, 31c, 31d, and the cathode 33a, 33b, 33c, 33d during operation of the battery 25. The stacks may be coupled electrically in series and/or in parallel (not shown). The assembly of stacks 30a, 30b, 30c, 30d is shielded by a top barrier layer 36. The top barrier layer 36 is preferably made of tantalum, titanium, tantalum nitride, or titanium nitride, and will hence be a relatively rigid layer. Physical adhesion between the relatively rigid top barrier layer 36 and the side walls and top surface of the assembly of stacks 30a, 30b, 30c, 30d is considered undesirable, since cracking of the top barrier layer 35 will commonly easily occur due to expansion and contraction of the anode 31a, 31b, 31c, 31d and the cathode 33a, 33b, 33c, 33d during operation of the battery 25. Therefore the side walls of the assembly of stacks 30a, 30b, 30c, 30d are each covered by a flexible element 37a, 37b to compensate the aforementioned expansion and contraction. A material stress reducing cavity 38 is applied between a top surface of the assembly of stacks 30a, 30b, 30c, 30d and the surrounding top barrier layer 35 to compensate an eventual total volume change of the stacks 30a, 30b, 30c, 30d in a direction perpendicular to the substrate 26 during operation of the battery 25 according to the invention. In this manner, a detrimental built-up of material stress in the protective top barrier layer 35 can be prevented, or at least counteracted, as a result of which an optimum shielding of the stacks 30a, 30b, 30c, 30d, and hence an optimum performance of the battery 25 can be maintained relatively long-lastingly.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
a substrate, and
at least one stack deposited onto said substrate, the stack comprising:
an first electrode,
a second electrode, and
an intermediate solid-state electrolyte separating the first electrode and the second electrode; and
at least one electron-conductive barrier layer being deposited between the substrate and the stack, which barrier layer is adapted to at least substantially preclude diffusion of active species of the stack into said substrate,
wherein the energy source further comprises at least one material layer surrounding the stack at least partially, and a stress reducing means positioned between the stack and the surrounding material layer for reducing stress in the surrounding material layer during expansion and contraction of the stack.

2. Electrochemical energy source according to claim 1, characterized in that the first electrode comprises an anode, and/or that the second electrode comprises a cathode.

3. Electrochemical energy source according to claim 2, characterized in that both the anode and the cathode are adapted for storage of active species of at least one of following elements: H, Li, Be, Mg, Cu, Ag, Na and K.

4. Electrochemical energy source according to claim 2, characterized in that at least one of the anode and the cathode is made of at least one of the following materials: C, Sn, Ge, Pb, Zn, Bi, Li, Sb, and, preferably doped, Si.

5. Electrochemical energy source according to claim 1, characterized in that the at least one electrode of the first electrode and the second electrode comprises at least one current collector.

6. Electrochemical energy source according to one claim 5, characterized in that the at least one current collector is made of at least one of the following materials: Al, Ni, Pt, Au, Ag, Cu, Ta, Ti, TaN, and TiN.

7. Electrochemical energy source according to claim 1, characterized in that the stress reducing means comprises at least one stress reducing cavity formed between the stack and the surrounding material layer.

8. Electrochemical energy source according to claim 7, characterized in that the stress reducing means comprises multiple stress reducing cavities.

9. Electrochemical energy source according to claim 1, characterized in that the stress reducing means comprises at least one flexible element.

10. Electrochemical energy source according to claim 9, characterized in that the stress reducing means comprises multiple flexible elements.

11. Electrochemical energy source according to claim 9, characterized in that the at least one flexible element comprises at least one polymer, in particularly parylene.

12. Electrochemical energy source according to claim 1, characterized in that the material stress reducing means is adapted for separating different stacks.

13. Electrochemical energy source according to claim 1, characterized in that the surrounding material layer comprises a packaging covering an outer surface of said stack at least partially.

14. Electrochemical energy source according to claim 13, characterized in that the packaging is electrically insulating contained by the stack.

15. Electrochemical energy source according to claim 1, characterized in that the at least one barrier layer is made of at least one of the following materials: Ta, TaN, Ti, and TiN.

16. Electrochemical energy source according to claim 1, characterized in that the substrate comprises Si and/or Ge.

17. Electronic device provided with at least one electrochemical energy source according to claim 1.

18. Electronic device according to claim 17, characterized in that the at least one electronic component, in particular an integrated circuit (IC), is at least partially embedded in the substrate of the electrochemical energy source.

19. Electronic device according to claim 18, characterized in that the electronic device and the electrochemical energy source form a System in Package (SiP).
